(19) United States
(12) Patent Application Publication
(10) Pub. No.: US 2025/0371749 A1
(43) Pub. Date: Dec. 4, 2025

(54) NON-TRANSITORY INFORMATION PROCESSING COMPUTER-READABLE RECORDING MEDIUM, INFORMATION PROCESSING METHOD, AND INFORMATION PROCESSING APPARATUS

(71) Applicant: Fujitsu Limited, Kawasaki-shi (JP)

(72) Inventor: Hiroaki KINGETSU, Kawasaki (JP)

(73) Assignee: Fujitsu Limited, Kawasaki-shi (JP)

(21) Appl. No.: 19/212,773

(22) Filed: May 20, 2025

(30) Foreign Application Priority Data
May 28, 2024 (JP) 2024-086680

(51) Int. Cl. G06T 11/00; G06T 5/70; G06V 10/764

(52) U.S. Cl. CPC G06T 11/00; G06T 5/70; G06V 10/764; G06T 2207/20182

(57) ABSTRACT

A non-transitory computer-readable recording medium has stored therein a program that causes a computer to execute a process includes, selecting some modules from a plurality of modules to be applied to a trained machine learning model that performs image generation by performing noise removal from random noise up to a final stage among a plurality of stages, generating a first image by synthesizing selected modules and performing noise removal from predetermined random noise to a stage in the middle before reaching the final stage, generating a second image by performing noise removal from the first image a predetermined number of times for each module included in the plurality of modules, and classifying a module included in the plurality of modules based on the second image for each of the modules.

### CROSS-REFERENCE TO RELATED APPLICATION

This application is based upon and claims the benefit of priority of the prior Japanese Patent Application No. 2024-086680, filed on May 28, 2024, the entire contents of which are incorporated herein by reference.

### FIELD

The embodiment discussed herein is related to an non-transitory information processing computer-readable recording medium, an information processing method, and an information processing apparatus.

### BACKGROUND

As a technique of image generation using artificial intelligence (AI), image generation using a diffusion model has attracted attention. The diffusion model is an image generation model that generates an image by executing denoise for removing noise from an image of random noise according to a prompt that is a conditional text for image generation.

Since the diffusion model is a large-scale model, high-performance hardware and many calculation resources are used to perform fine tuning (FT) on the entire diffusion model. Therefore, it is important to reduce the size of the model to be fine-tuned. Therefore, a method of preparing a specific layer or an additional layer of the diffusion model (parameter-efficient fine-tuning (PEFT)) has been studied instead of tuning the entire original diffusion model. PEFT includes, for example, a technique such as an adapter or low-rank adaptation (LORA). This particular layer or additional layer is referred to as a module.

The module performs training for a specific application, and for example, there is a module that has performed training of processing of a color painting style such as watercolor painting or animation painting on a picture. The diffusion model can acquire generation capability according to a module for a specific application by replacing the module. Returning to the original module, the generation capability for the specific task of the diffusion model returns to the original generation capability.

However, in a module subjected to fine tuning for a specific application, an influence of a prompt trained in the original diffusion model is reduced, so that control by the prompt is considerably difficult. However, a user often does not know which module is suitable for the request. Therefore, in a case where fine tuning of the diffusion model by PEFT is performed, the user searches for a module that can output an output closest to a desired image. Therefore, it is conceivable to group modules having high similarity on the basis of feedback from the user for each output in a case where a plurality of modules is used. If appropriate grouping can be performed, it is possible to use a preferential module from the group according to the request of the user and present the new subsequent task to the user.

Note that, as a technique related to training of an image generation model, a technique for causing an image generation model to perform training using a mean square error and structural similarity (SSIM) has been proposed.

Patent Literature 1: Japanese Laid-open Patent Publication No. 2023-7107

### SUMMARY

According to an aspect of an embodiment, a non-transitory computer-readable recording medium has stored therein a program that causes a computer to execute a process. The process includes, selecting some modules from a plurality of modules to be applied to a trained machine learning model that performs image generation by performing noise removal from random noise up to a final stage among a plurality of stages, generating a first image by synthesizing selected modules and performing noise removal from predetermined random noise to a stage in the middle before reaching the final stage, generating a second image by performing noise removal from the first image a predetermined number of times for each module included in the plurality of modules, and classifying a module included in the plurality of modules based on the second image for each of the modules.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an information processing apparatus according to an embodiment;

FIG. 2 is a diagram illustrating image generation by a diffusion model;

FIG. 3 is a diagram illustrating training by adding a module;

FIG. 4 is a diagram for describing similarity of outputs;

FIG. 5 is a flowchart of module clustering processing;

FIG. 6 is a flowchart of module proposal processing; and

FIG. 7 is a hardware configuration diagram of the information processing apparatus.

### DESCRIPTION OF EMBODIMENTS

However, it takes some time to replace the module and generate the image using the diffusion model. In addition, the calculation of the similarity takes a lot of time and effort. Therefore, it takes a lot of time to select modules having high similarity, and it is difficult to realize a method of grouping modules having high similarity on the basis of feedback from the user for each output in a case where a plurality of modules is simply used. Therefore, it is difficult to improve the training efficiency of the diffusion model, and as a result, it is difficult to shorten the time spent on image generation. In addition, in the technology of causing the image generation model to perform training using the SSIM together with the mean square error, grouping based on model similarity is not considered, and it is difficult to improve the training efficiency of the diffusion model, and it is difficult to shorten the time required for image generation work.

Preferred embodiments of the present invention will be explained with reference to accompanying drawings. Note that the non-transitory information processing computer-readable recording medium, the information processing method, and the information processing apparatus disclosed in the present application are not limited by the following embodiments.

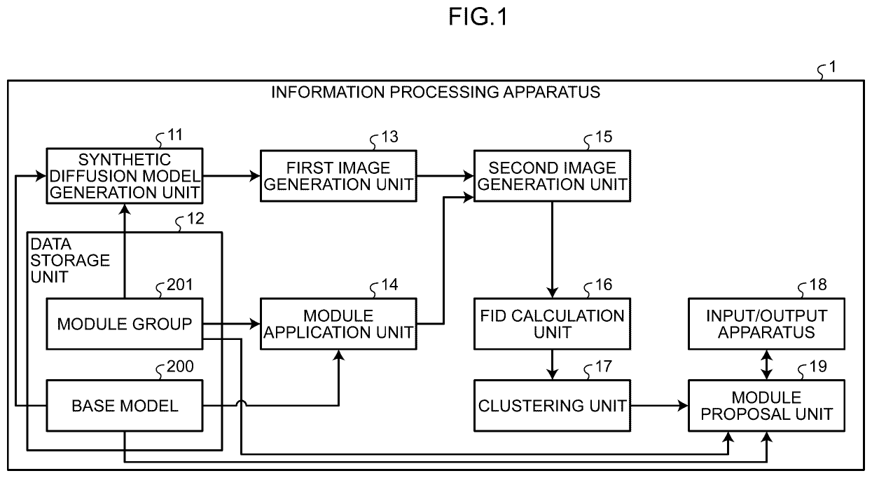

FIG. 1 is a block diagram illustrating an information processing apparatus according to an embodiment. As illustrated in FIG. 1, an information processing apparatus 1 according to the present embodiment includes a synthetic diffusion model generation unit 11, a data storage unit 12, a first image generation unit 13, and a module application unit 14. The information processing apparatus 1 further includes a second image generation unit 15, a Frechet inception distance (FID) calculation unit 16, a clustering unit 17, an input/output apparatus 18, and a module proposal unit 19.

The data storage unit 12 is a storage device. The data storage unit 12 stores a module group 201 and a base model 200.

The base model 200 is a trained diffusion model as a source to be a target of fine tuning using a module.

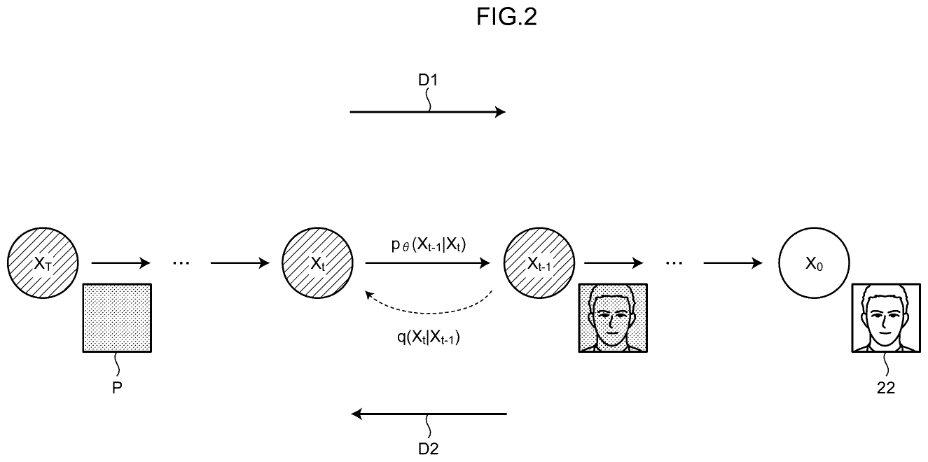

Here, the diffusion model will be described. FIG. 2 is a diagram illustrating image generation by the diffusion model. The diffusion model is given in advance a conditioning text for image generation. Then, the diffusion model is a machine learning model that repeats denoise for removing noise with respect to a random noise P and finally generates a desired image 22. X_{T}, . . . , Xₜ, Xₜ₋₁, . . . , X₀ are the data corresponding to each of the images including the random noise p and the desired image 22, respectively.

The processing by the diffusion model includes a diffusion process in the direction of an arrow D2 and a reverse diffusion process in the direction of an arrow D1. The reverse diffusion process is an image generation process. And, p_{θ} (Xₜ₋₁|Xₜ) is a function that denoises Xₜ to generates Xₜ₋₁ in the inverse diffusion process. Also, q (Xₜ|Xₜ₋₁) is a function that generates Xₜ from Xₜ₋₁ in the diffusion process.

The diffusion process is a process of gradually adding Gaussian noise to the image 22. In the diffusion process, noise is simply added to the image 22. The reverse diffusion process repeats the denoise process of gradually removing noise, and finally generates the clear image 22.

The diffusion model trains which noise to erase to follow the reverse of the diffusion process. The trained diffusion model predicts an image to be generated in response to a new random noise P and the prompt, thereby generating the final image 22.

Returning to FIG. 1, the description will be continued. The module group 201 includes a large number of modules. In the module group 201, modules intended to perform processing for a specific application are collected. The processing for a specific use is, for example, processing of performing coloring according to a painting style in image generation, processing of adding a new concept such as a person or an object, or the like.

The modules are some layers of the diffusion model. The module is created using parameter-efficient fine-tuning (PEFT) that tunes parameters of some layers to be subjected to the module in the diffusion model. Among the fine tuning of the diffusion model using PEFT, there are some methods of inserting a module into the diffusion model and applying the module to a new task, but in the present embodiment, a method called low-rank adaptation (LoRA) is used. Other methods for fine-tuning a diffusion model using PEFT include Adapter, Parallel Bottleneck Adapter, and (IA)\hat{ }3.

LoRA is a method of saving resources to be used by representing a weight matrix by a low-rank matrix. In LoRA, a weight matrix is represented by being decomposed into two low-rank matrices and a scaling hyperparameter. This decomposition is applicable to specific parameter groups. For example, it is applied to a linear projection portion of attention of each transformer layer in the diffusion model. Then, the weight of the low-rank matrix is added in parallel to the weight of the original model (Pretrained Weights) to obtain the final model. The weights of the original model are also referred to as model parameters. Processing of adding the weight of the low-rank matrix in parallel to the weight of the original model corresponds to addition of a module. In addition, training the weight of the low-rank matrix corresponds to module training. As a result, it is possible to reduce the calculation load while maintaining the performance of the diffusion model.

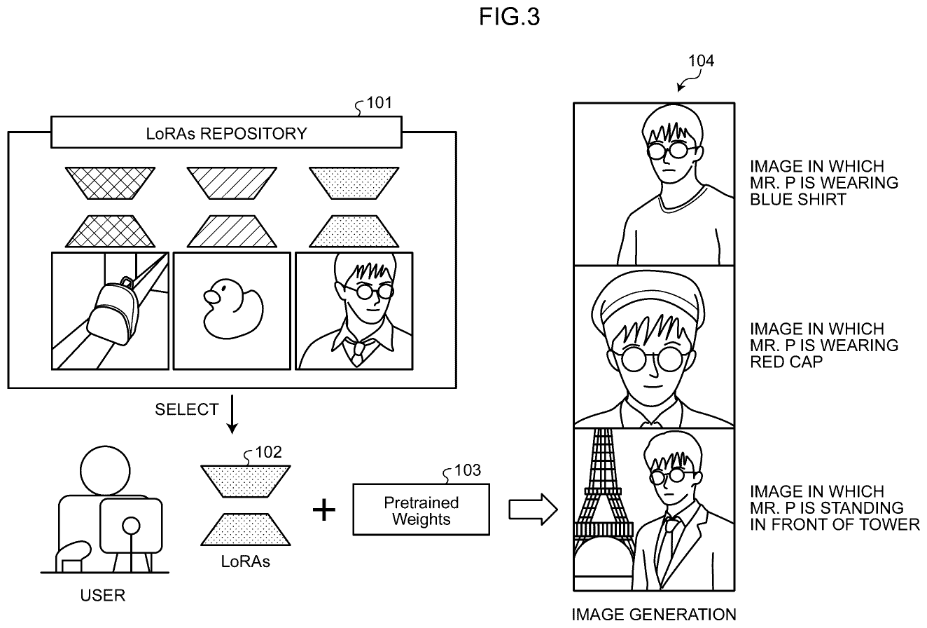

FIG. 3 is a diagram illustrating training by adding a module. Here, a plurality of LoRAs for adding various concepts such as a bag, a toy of a chick, and Mr. P are put together in a LoRAs repository 101. When fine-tuning the diffusion model, the user selects a module 102 of LoRA to which Mr. P is added as a desired concept from the LoRAs repository 101. Then, the user adds the weight of the low-rank matrix indicated by module 102 to a pretrained Weights 103 which are the weights of the original model of the diffusion model, and performs fine tuning of the diffusion model. The diffusion model subjected to the fine tuning can generate various images 104 to which a new concept of Mr. P is added.

The synthetic diffusion model generation unit 11 acquires a plurality of modules in the module group 201 from the data storage unit 12. In addition, the synthetic diffusion model generation unit 11 acquires the base model 200 from the data storage unit 12.

Then, the synthetic diffusion model generation unit 11 synthesizes the plurality of acquired modules and applies the synthetic modules to the base model 200 to generate a synthetic diffusion model. Here, the synthetic diffusion model generation unit 11 synthesizes the modules by synthesizing the weights of the modules. Specifically, the synthetic diffusion model generation unit 11 obtains an average of the sums of weights of the modules, and generates a synthetic diffusion model using the obtained value as a weight. In the case of LoRA, the synthetic diffusion model generation unit 11 averages the weights attached to the edges of neurons of LoRA.

However, it is not clear whether the sizes and ranks of the modules are unified. It is difficult to calculate the sum of weights unless the size and rank of each module are matched. Therefore, it is preferable that the synthetic diffusion model generation unit 11 synthesize the modules of the size and in the same rank whose number is the largest, for example, so as to align the sizes and ranks of the modules and then synthesize the modules. In addition, the synthetic diffusion model generation unit 11 may generate the synthetic diffusion model by synthesizing modules of the same size as much as possible.

In the present embodiment, synthesizing a plurality of modules is exemplified, but processing may be performed by selecting one module instead of synthesizing a plurality of modules.

The synthetic diffusion model generation unit 11 outputs the generated synthetic diffusion model to the first image generation unit 13.

The first image generation unit 13 receives an input of the synthetic diffusion model from the synthetic diffusion model generation unit 11. Then, the first image generation unit 13 generates a first image by executing denoise for the random noise with the fixed seed a predetermined number of times using the synthetic diffusion model. In a case where an image that satisfies the requirement can be generated by 50 times of denoise, the first image generation unit 13 may execute 45 to 47 times of denoise, for example. Thereafter, the first image generation unit 13 outputs the generated first image to the second image generation unit 15.

Here, it is difficult to obtain the characteristics of each module by the denoise in the initial part of the diffusion process with respect to the random noise. On the other hand, in the case of the denoise in the last part of the diffusion process, the denoise becomes denoise for bringing the image closer the final image, and the difference in the features of the module becomes clear. Therefore, in a case where the similarity between the modules is simply measured and clustering is intended, denoise near the final step of the diffusion process is important.

Therefore, the first image generation unit 13 generates an initial image by using a synthetic diffusion model including features of various modules, performs denoise from the first image as the initial image, and generates a second image, thereby making it easy to obtain features of each module. Note that the first image may be other than the initial image.

Further, the first image generation unit 13 generates the first image using the random noise in which the seed is changed for the plurality of seeds. Then, the first image generation unit 13 outputs a plurality of first images generated from random noise of different seeds to the second image generation unit 15.

The module application unit 14 acquires the base model 200 from the data storage unit 12. Next, one module is selected and acquired from the module group 201 and applied to the base model 200 to generate a diffusion model. Thereafter, the module application unit 14 outputs the diffusion model to which the selected module is applied to the second image generation unit 15.

The module application unit 14 selects modules one by one from the module group 201, applies the modules to the base model 200 described above, and then sequentially outputs the diffusion model to the second image generation unit 15.

The second image generation unit 15 receives an input of the plurality of first images generated from random noise of different seeds from the first image generation unit 13. In addition, the second image generation unit 15 receives an input of the diffusion model to which the selected module is applied from the module application unit 14.

Then, the second image generation unit 15 generates the second image as the final image by repeating denoise a predetermined number of times using the diffusion model acquired for the first image generated from the random noise of the specific seed. For example, the second image generation unit 15 executes denoise two or three times to obtain the second image. Note that the second image may be other than the final image.

In other words, for each module included in the plurality of modules, noise is removed from the first image a predetermined number of times to generate the second image. The second image may be generated after removing noise from the first image up to the final stage.

The second image generation unit 15 receives an input of a diffusion model to which another module is applied from the module application unit 14, and generates the second image from the first image generated from the random noise of the same specific seed. At this time, the second image generation unit 15 uses the same numerical value for each module in the prompt. As a result, the second image generation unit 15 acquires each second image obtained from the first image generated from the random noise of the specific seed for all the modules included in the module group 201.

Here, the second image generation unit 15 can generate the second image using modules other than the modules used for generating the synthetic diffusion model. This is because the reverse diffusion process can be applied to the first image in the middle of the reverse diffusion process regardless of the size or the like.

Furthermore, the second image generation unit 15 similarly acquires the second images generated from the respective diffusion models to which all the modules included in the module group 201 are applied for the first images generated from the random noises having different seeds. Thereafter, the second image generation unit 15 outputs each of the second images obtained from the diffusion model to which each module is applied to the FID calculation unit 16 for each of the first images having different seeds.

Here, in the present embodiment, since the second image is obtained from the first image, the quality of the final product does not reach the quality of the final product generated by each module alone from the initial random noise. However, in the similarity calculation, it is sufficient that a difference can be generated in the generated image for each module up to a clusterable level. Therefore, even a second image having poor quality can be used for calculating the similarity. Specifically, the second image can be used as long as the similarity of the Frechet distance between the Gaussian distributions described below can be calculated and the reverse diffusion process can be advanced to such an extent that the minimum distance between the clusters is equal to or more than the threshold. If such a second image can be obtained, the object of classifying modules can be achieved even if clustering is performed with an image different from the final product.

The FID calculation unit 16 receives, from the second image generation unit 15, an input of each of the second images obtained from the diffusion model to which each module is applied, for each of the first images having different seeds. Then, the FID calculation unit 16 selects a pair of modules and calculates the FID from the second image in a case where each module is applied.

The FID is a method for measuring a distance between two data distributions in the generation model. The FID calculation unit 16 executes the following calculation steps to calculate the FID.

The FID calculation unit 16 extracts a feature from each of the second image corresponding to one module and the second image corresponding to the other module using the Inception network which is a network for classification. Next, the FID calculation unit 16 fits the multivariate Gaussian distribution to each data set (the second image corresponding to one module and the second image corresponding to the other module) from the extracted features, and calculates an average and a covariance matrix of the feature amounts. Next, the FID calculation unit 16 calculates the Frechet distance between the two Gaussian distributions by using the mean vector and the covariance matrix of the two multivariate Gaussian distributions in the following Formula (1). This Frechet distance corresponds to the FID.

$$FID ( x , g ) = {‖ {μ}_{x} - {μ}_{g} ‖}^{2} + Tr ( {\sum }_{x} + {\sum }_{g} - 2 {( {\sum }_{x} {\sum }_{g} )}^{1 / 2} ) \qquad ( 1 )$$

Here, μₓ and ρₓ represent an average and a covariance matrix of the data distribution of one second image. In addition, μ_{g} and Σ_{g} represent an average and a covariance matrix of the data distribution of the other second image. In addition, “∥ μ” indicates the Euclidean norm. In addition, Tr indicates a trace that is the sum of the diagonal components of the matrix.

Thereafter, the FID calculation unit 16 outputs the calculated FIDs of the modules to the clustering unit 17.

The clustering unit 17 receives an input of the FID between the modules from the FID calculation unit 16. Then, the clustering unit 17 clusters the modules using the FID, and clusters the modules. Here, if the FID is close, it indicates that the second images between the modules are close, and it can be considered that the similarity is high. For example, the clustering unit 17 can perform clustering using the k-means method.

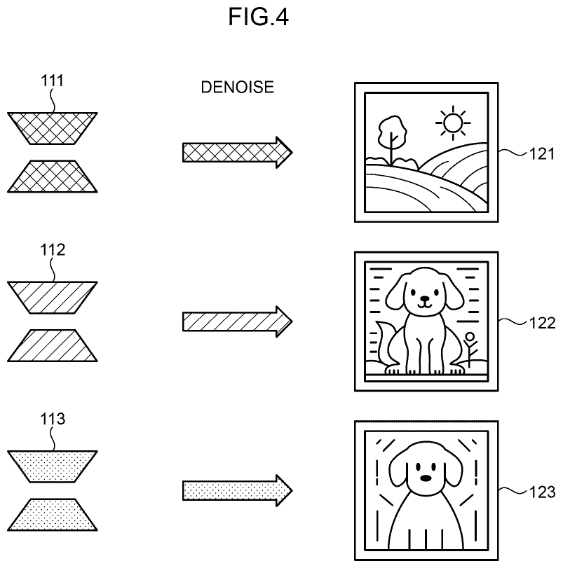

FIG. 4 is a diagram for describing similarity of outputs. As illustrated in FIG. 4 finally, for example, in a case where there are modules 111 to 113 used in LORA, the clustering unit 17 provides an index indicating which of the images 121 to 123 created by the modules is similar to which of the images, and which of the images is different from which of the images. For example, the clustering unit 17 sets the module 112 and the module 113 as the same cluster because the image 122 and the image 123 are similar, and sets the module 111 as a different cluster because the image 121 is different from the others. As a result, it can be seen that a similar image is generated in a case where the module 112 and the module 113 are applied to the diffusion model, but an image, which is different from the image generated in a case where the module 112 or the module 113 is applied, is generated in a case where the module 111 is applied.

The input/output apparatus 18 includes an input device such as a keyboard and a mouse and an output device such as a monitor. The user can confirm information provided by the information processing apparatus 1 and can input a command, information, and the like using the input/output apparatus 18.

The module proposal unit 19 acquires information on each cluster of the clustered modules from the clustering unit 17. Next, the module proposal unit 19 extracts a module to be the center of each cluster. Then, the module proposal unit 19 acquires the module and the base model 200 extracted from the module group 201 from the data storage unit 12. Then, the module proposal unit 19 generates a diffusion model by applying the module to the base model 200 for each module at the center of each cluster, and generates an image using the generated model. Next, the module proposal unit 19 outputs an image of each module at the center of each cluster to the input/output apparatus 18 to display the image, and presents the image to the user.

Thereafter, the module proposal unit 19 receives, from the input/output apparatus 18, an input of information of an image selected from among images for each module at the center of each cluster as an image closest to the image desired to be created by the user. Next, the module proposal unit 19 acquires some modules at a nearby distance similar to the module that generated the selected image from the module group 201 of the data storage unit 12. Then, the module proposal unit 19 generates an image for each module by using a module at a nearby distance similar to the module that has generated the selected image, and presents the image to the user.

Thereafter, the module proposal unit 19 receives, from the input/output apparatus 18, an input of information of an image reselected from among images of each module at a nearby distance similar to the module that has generated the selected image, as the image closest to the image desired to be created by the user. Here, the module proposal unit 19 inquires of the user whether to accept the selected image as the final result using the input/output apparatus 18. If the user accepts the image, the selected image is set as a final result, and information on the module used to generate the image is provided to the user using the input/output apparatus 18.

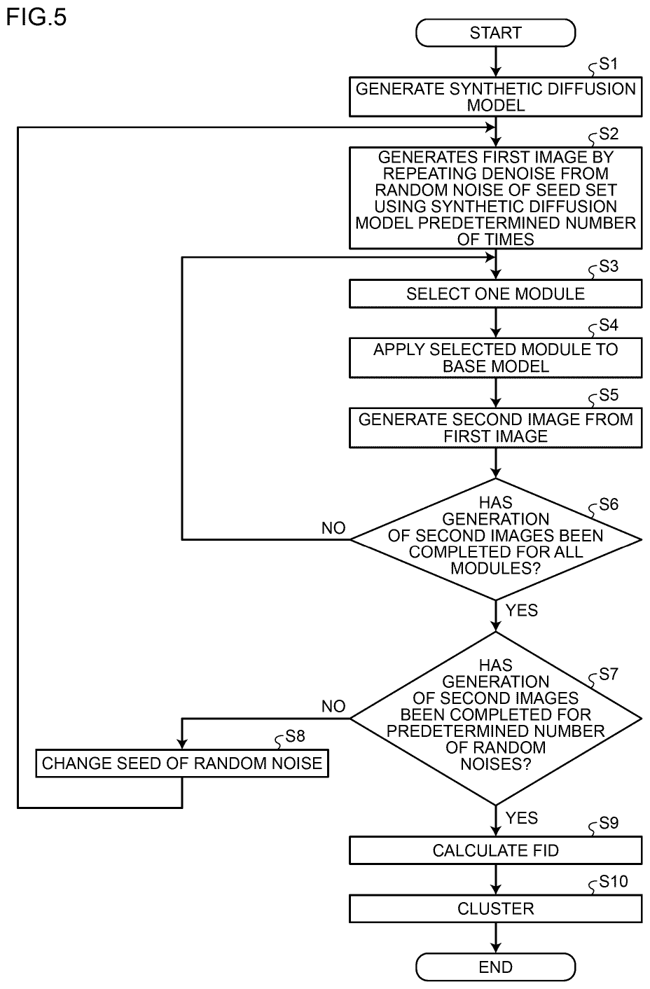

FIG. 5 is a flowchart of module clustering processing. Next, a procedure of module clustering processing by the information processing apparatus 1 according to the present embodiment will be described with reference to FIG. 5.

The synthetic diffusion model generation unit 11 acquires a plurality of modules in the module group 201 from the data storage unit 12. In addition, the synthetic diffusion model generation unit 11 acquires the base model 200 from the data storage unit 12. Then, the synthetic diffusion model generation unit 11 synthesizes the plurality of acquired modules and applies the synthetic modules to the base model 200 to generate a synthetic diffusion model (step S1).

The first image generation unit 13 generates the first image by repeating denoise from the random noise of the seed set using the synthetic diffusion model a predetermined number of times (step S2). Here, the first image generation unit 13 has received the setting of the seed to be used first in advance.

The module application unit 14 selects one module from unselected modules in the module group 201 (step S3).

Next, the module application unit 14 generates a diffusion model by applying the selected module to the base model 200 (step S4).

The second image generation unit 15 generates the second image using the diffusion model generated by the module application unit 14 for the first image generated by the first image generation unit 13 (step S5).

Next, the second image generation unit 15 determines whether or not the second images have been generated for all the modules included in the module group 201 (step S6). If there is a module that has not generated the second image (step S6: No), the clustering processing returns to step S3.

On the other hand, if the second images have been generated for all the modules included in the module group 201 (step S6: Yes), the second image generation unit 15 determines whether or not the generation of the second images for the predetermined number of random noises having different seeds has been completed (step S7). If there is a random image of a seed for which the second image has not been generated (step S7: No), the synthetic diffusion model generation unit 11 changes the seed of the random noise to another unused seed (step S8). Thereafter, the clustering processing returns to step S2.

On the other hand, if the generation of the second image for the predetermined number of random noises having different seeds is completed (step S7: Yes), the second image generation unit 15 outputs a plurality of images generated from a plurality of random noises having different seeds for each module to the FID calculation unit 16. The FID calculation unit 16 calculates each FID between the modules (step S9).

The clustering unit 17 clusters the modules using the FID calculated by the FID calculation unit 16 (step S10).

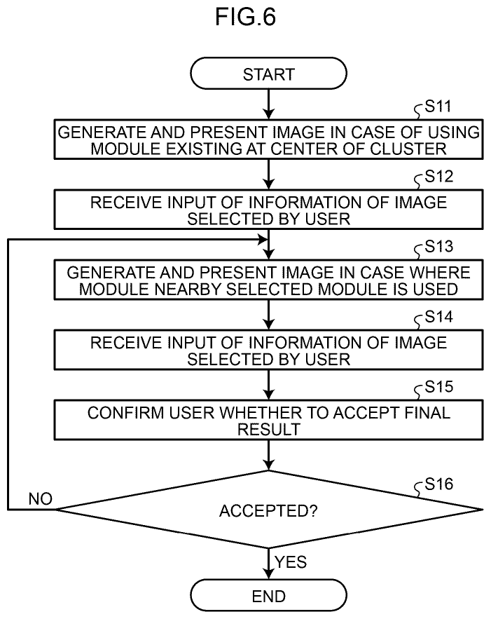

FIG. 6 is a flowchart of module proposal processing. Next, a procedure of module proposal processing by the information processing apparatus 1 according to the present embodiment will be described with reference to FIG. 6.

The module proposal unit 19 extracts a module existing at the center of each cluster of modules generated by the clustering unit 17 and acquires the module from the module group 201. Next, the module proposal unit 19 applies each extracted module to the base model 200, generates each image, and displays the image on the input/output apparatus 18. As a result, the module proposal unit 19 presents each image in a case where the extracted module is used to the user (step S11).

Next, the module proposal unit 19 receives, from the input/output apparatus 18, an input of information of an image selected by the user from among the respective images in a case where the extracted module is used (step S12).

Next, the module proposal unit 19 applies a module nearby the selected module to the base model 200, generates each image, and displays the image on the input/output apparatus 18. As a result, the module proposal unit 19 presents each image in a case where the module nearby the selected module is used to the user (step S13).

Next, the module proposal unit 19 receives, from the input/output apparatus 18, an input of information of an image selected by the user from among the respective images in a case where the module nearby the selected module is used (step S14).

Next, the module proposal unit 19 confirms whether or not the selected image is accepted as a final result using the input/output apparatus 18 (step S15).

Then, the module proposal unit 19 determines whether or not the user has accepted the input according to the input from the input/output apparatus 18 (step S16). If the user does not accept the image (step S16: No), the module proposal unit 19 returns to step S13.

On the other hand, if the user has accepted (step S16: Yes), the module proposal unit 19 provides the user with the information of the module used to generate the selected image, and ends the module proposal processing.

As described above, the information processing apparatus according to the present embodiment generates a synthetic diffusion model by synthesizing appropriate modules and applying the synthesized modules to the base model. Then, using the generated synthetic diffusion model, noise is removed from a predetermined random noise to a stage halfway before reaching the final stage among a plurality of stages regarding noise removal, thereby generating a first image. Then, the information processing apparatus performs noise removal from the first image a predetermined number of times by using the diffusion model to which each module is applied, and generates each second image. Thereafter, the information processing apparatus clusters the modules using the generated second image, and proposes a desired module to the user using the cluster of modules.

The second image from the first image model can be created by several times of denoise processing, and the step of generating the second image for each module can be shortened. Therefore, it is possible to speed up the FID calculation between the modules as a whole, it is possible to perform clustering according to the features of the modules in a short time, and it is possible to easily propose an appropriate module to the user using the cluster. Therefore, it is possible to propose an appropriate module to the user in a short time, and it is possible to shorten the time required for the image generation work.

For example, in the case of scheduling of a general reverse diffusion process, the denoise in the diffusion model in which each module is applied to the first image generated using the synthetic diffusion model can sufficiently calculate the similarity by two to three times. On the other hand, in order to generate the second image using the diffusion model to which each module is applied from the initial random noise, the denoise is performed about 40 times. That is, the speed of the FID calculation can be expected to be about 20 times, and the calculation cost of the similarity between the modules can be greatly reduced.

On the other hand, the cost of each calculation added to realize the function of the information processing apparatus according to the present embodiment is very low. Specifically, the cost is the calculation cost of the weight calculation of the synthetic module and the calculation cost until the first image in the middle of the reverse diffusion process using the synthetic module is obtained. The calculation until obtaining the first image in the middle of the reverse diffusion process using the synthetic module is once, and as the number of target modules increases, the cost reduction effect in the case of using the information processing apparatus according to the present embodiment increases, which is advantageous in total.

For example, in the case of measuring the distance of the weight between the modules, the calculation speed becomes high, but the sizes and ranks of the modules are supposed to be exactly the same, and it is unrealistic to actually perform clustering using this distance. In addition, in a case where the second image is generated from the first image using the diffusion model to which all the modules are applied and the FID is calculated, although calculation is possible, it is difficult to realize the calculation because a large number of calculations are performed. On the other hand, in the case of clustering by the information processing apparatus according to the present embodiment, calculation can be done as long as it is possible to output an image in a case where each module is used regardless of the size or rank of the module, and the calculation can be done at high speed.

As a method of selecting a module, there is also a method of using direct designation from a module group by a user. For example, as one method, there is a method of a selective color of a range region by color specification. This is achieved by the user directly specifying RGB to restrict the color tone. As another method, there is a method of specifying a color tone by using prompt. This method is achieved by the user directly specifying the color tone using words. In addition, as another method, there is a method of listing and tagging trained modules. This can be searched by listing and manually tagging the generation results of the modules.

However, in the method of the selective color of a range region by color selection, obtaining a generation result is repeated to obtain a target output, which takes time. In addition, each time the module is used, the user performs the specification from the beginning, and it is difficult to efficiently perform the method. Furthermore, although the color can be brought close to the color desired by the user, it is difficult to perform complicated specification.

Even by the method of specifying the color tone, obtaining a generation result is repeated to obtain a target output, which takes time. In addition, also in this method, each time the module is used, the user performs the specification from the beginning, and it is difficult to efficiently perform the method. Further, there is a problem that it is difficult to select a prompt to improve quality.

In the case of the method of listing and tagging the trained modules, since the listing and tagging used in the past can be reused, efficiency can be improved. However, it takes a lot of time to obtain the outputs of all the modules in advance. In addition, it is not possible to perform comparison in a case where each module is used at the same prompt, and it is not clear whether a module that meets the user's desire can be obtained. Furthermore, in a case where the tag is not appropriately added, the tag is selected from many modules, and it is difficult to find an appropriate module.

On the other hand, in a case where the information processing apparatus 1 according to the present embodiment is used, by selecting a module from among the generated clusters, unnecessary calculation is omitted, and an appropriate module can be easily obtained. In addition, by using the already generated cluster, it is possible to efficiently propose a module. Furthermore, since the feedback of the user can be immediately reflected, it is possible to propose an appropriate module further according to the desire of the user, and the user experience is improved.

### Hardware Configuration

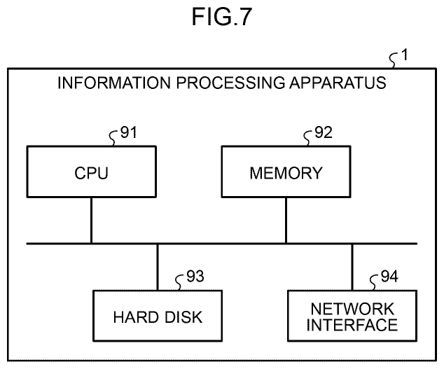

FIG. 7 is a hardware configuration diagram of the information processing apparatus. Next, an example of a hardware configuration for realizing each function of the information processing apparatus 1 will be described with reference to FIG. 7.

As illustrated in FIG. 7, the information processing apparatus 1 includes, for example, a central processing unit (CPU) 91, a memory 92, a hard disk 93, and a network interface 94. The CPU 91 is connected to the memory 92, the hard disk 93, and the network interface 94 via a bus.

The network interface 94 is an interface for communication between the information processing apparatus 1 and an external device.

The hard disk 93 is an auxiliary storage device. The hard disk 93 implements the functions of the data storage unit 12 illustrated in FIG. 1. In addition, the hard disk 93 stores various programs including the following programs. For example, the hard disk 93 stores a program for implementing the functions of the synthetic diffusion model generation unit 11, the first image generation unit 13, the module application unit 14, and the second image generation unit 15 illustrated in FIG. 1. In addition, the hard disk 93 stores a program for realizing the functions of the FID calculation unit 16, the clustering unit 17, the input/output apparatus 18, and the module proposal unit 19 illustrated in FIG. 1.

The memory 92 is a main storage device. For example, a dynamic random access memory (DRAM) can be used as the memory 92.

The CPU 91 reads various programs from the hard disk 93, implements the programs in the memory 92, and executes the programs. As a result, the CPU 91 implements the functions of the synthetic diffusion model generation unit 11, the first image generation unit 13, the module application unit 14, the second image generation unit 15, the FID calculation unit 16, the clustering unit 17, the input/output apparatus 18, and the module proposal unit 19 illustrated in FIG. 1.

In one aspect, the present invention can shorten the time required for image generation work.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
selecting some modules from a plurality of modules to be applied to a trained machine learning model that performs image generation by performing noise removal from random noise up to a final stage among a plurality of stages;
generating a first image by synthesizing selected modules and performing noise removal from predetermined random noise to a stage in the middle before reaching the final stage;
generating a second image by performing noise removal from the first image a predetermined number of times for each module included in the plurality of modules; and
classifying a module included in the plurality of modules based on the second image for each of the modules.

2. The non-transitory computer-readable recording medium according to claim 1, wherein in the synthesizing, an average of weights of the modules is calculated, and a calculated value is used as a weight.

3. The non-transitory computer-readable recording medium according to claim 1, wherein the classifying of the modules includes a process of calculating a distance between the modules based on the second image and performing classification based on the calculated distance.

4. The non-transitory computer-readable recording medium according to claim 3, wherein a generating process of the second image includes a process of executing noise removal from the first image for the number of times so that the shortest distance between the classifications based on the distance between the modules calculated based on the second image is equal to or more than a threshold.

5. The non-transitory computer-readable recording medium having stored therein a program according to claim 1, further causing a computer to execute a process including selecting one module from each of the classifications, generating an image for each selected module based on a specific random noise using the machine learning model to which a module is applied, and presenting a plurality of images generated for each selected module to a user.

6. The non-transitory computer-readable recording medium having stored therein a program according to claim 5, further causing a computer to execute a process including:
receiving input of information of a selected image selected by a user from the plurality of presented images and reselecting a module close to a module used to generate the selected image; and
generating an image for each of the reselected module based on a specific random noise using the machine learning model to which a module is applied, and presenting a plurality of images generated for each selected module to a user.

7. An information processing method comprising:
selecting some modules from a plurality of modules to be applied to a trained machine learning model that performs image generation by performing noise removal from random noise up to a final stage among a plurality of stages;
generating a first image by synthesizing selected modules and performing noise removal from predetermined random noise to a stage in the middle before reaching the final stage;
generating a second image by performing noise removal from the first image a predetermined number of times for each module included in the plurality of modules; and
classifying a module included in the plurality of modules based on the second image for each of the modules, by a processor.

8. An information processing apparatus comprising:
a memory and;
a processor coupled to the memory and configured to:
select some modules from a plurality of modules to be applied to a trained machine learning model that performs image generation by performing noise removal from random noise up to a final stage among a plurality of stages;
generate a first image by synthesizing selected modules and performing noise removal from predetermined random noise to a stage in the middle before reaching the final stage;
generate a second image by performing noise removal from the first image a predetermined number of times for each module included in the plurality of modules; and
classify a module included in the plurality of modules based on the second image for each of the modules.
